(19) United States
(12) Patent Application Publication
(10) Pub. No.: US 2019/0213590 A1
(43) Pub. Date: Jul. 11, 2019

(54) MERCHANT PAYMENT SYSTEM FOR CRYTPOCURRENCY

(71) Applicant: John Eagleton, Taos, NM (US)

(72) Inventor: John Eagleton, Taos, NM (US)

(21) Appl. No.: 15/867,167

(22) Filed: Jan. 10, 2018

(51) Int. Cl. G06Q 20/40; G06K 19/06

(52) U.S. Cl. CPC G06Q 20/401; G06Q 2220/00; G06K 19/06037; G06K 19/06028

(57) ABSTRACT

Methods, systems, and devices for providing users with an option for selecting a cryoptocurrency payment method are described. A merchant payment apparatus may be used to collect payments using cryptocurrency. The merchant payment apparatus may then present the user with multiple payment options, including cryptocurrency payment options and non- cryptocurrency payment options. If a cryptocurrency payment option is selected, merchant payment apparatus may generate and display a machine readable label. A customer may scan the machine readable label and transmit a notification to a payment server. The payment server may then perform a cryptocurrency transaction, and may provide an indication to the merchant payment apparatus that the transaction is valid (i.e., that the cryptocurrency transaction has been completed or that funds are available for the completion of the transaction). After the merchant payment apparatus receives verification from the payment server, the sale may be completed.

### BACKGROUND

The following relates generally to accepting payments with cryptocurrency, and more specifically to providing users with an option for selecting a cryoptocurrency payment method.

Cryptocurrency may refer to a digital asset designed to work as a store of value and a medium of exchange using cryptography to secure transactions, control the creation of additional currency, and verify the transfer of assets. In some examples, cryptocurrency transactions may be aggregated and verified using blockchain technology. Examples of cryptocurrency may include Bitcoin, Ethereum, Bitcoin Cash, Ripple, Dash, Litecoin, and Monero. In some cases, vendors may not accept payments with cryptocurrency. This may result in inefficiencies, inconvenience, or barriers to adopting these currencies.

### SUMMARY

A merchant payment apparatus may be used by a merchant as a means to collect payment from customers using cryptocurrency. A customer may select goods or services for purchase. The merchant payment apparatus may then present the user with multiple payment options, including cryptocurrency payment options and non- cryptocurrency payment options. If a cryptocurrency payment option is selected, merchant payment apparatus may generate and display a machine readable label. A customer may scan the machine readable label and transmit a notification to a payment server. The payment server may then perform a cryptocurrency transaction, and may provide an indication to the merchant payment apparatus that the transaction is valid (i.e., that the cryptocurrency transaction has been completed or that funds are available for the completion of the transaction). After the merchant payment apparatus receives verification from the payment server, the sale may be completed.

In one embodiment, a method may include identifying a product for sale to a customer, displaying one or more payment options, the one or more payment options including a cryptocurrency payment option, receiving an indication that the customer has selected the cryptocurrency payment option, generating a machine readable label representing transaction information for the product based at least in part on the cryptocurrency payment option, and receiving a transaction verification from a payment server, wherein the transaction verification message is based at least in part on the machine readable label.

In one embodiment, a non-transitory computer-readable medium may include instructions operable to cause a processor to identify a product for sale to a customer, display one or more payment options, the one or more payment options including a cryptocurrency payment option, receive an indication that the customer has selected the cryptocurrency payment option, generate a machine readable label representing transaction information for the product based at least in part on the cryptocurrency payment option, and receive a transaction verification from a payment server, wherein the transaction verification message is based at least in part on the machine readable label.

In one embodiment, an apparatus may include a processor, memory in electronic communication with the processor, and instructions stored in the memory. The instructions may be operable to cause the processor to identify a product for sale to a customer, display one or more payment options, the one or more payment options including a cryptocurrency payment option, receive an indication that the customer has selected the cryptocurrency payment option, generate a machine readable label representing transaction information for the product based at least in part on the cryptocurrency payment option, and receive a transaction verification from a payment server, wherein the transaction verification message is based at least in part on the machine readable label.

In one embodiment, an apparatus may include means for identifying a product for sale to a customer, means for displaying one or more payment options, the one or more payment options including a cryptocurrency payment option, means for receiving an indication that the customer has selected the cryptocurrency payment option, means for generating a machine readable label representing transaction information for the product based at least in part on the cryptocurrency payment option, and means for receiving a transaction verification from a payment server, wherein the transaction verification message is based at least in part on the machine readable label.

Some examples of the method, non-transitory computer-readable medium, and apparatus described above may further include processes, features, means, or instructions for displaying a transaction verification message to a user based on the transaction verification from the payment server.

Some examples of the method, non-transitory computer-readable medium, and apparatus described above may further include processes, features, means, or instructions for presenting a plurality of product options, wherein identifying the product for sale to the customer may be based at least in part on the plurality of product options.

Some examples of the method, non-transitory computer-readable medium, and apparatus described above may further include processes, features, means, or instructions for identifying a transaction code from the transaction verification. Some examples of the method, non-transitory computer-readable medium, and apparatus described above may further include processes, features, means, or instructions for comparing the transaction code to the transaction information to verify the transaction.

Some examples of the method, non-transitory computer-readable medium, and apparatus described above may further include processes, features, means, or instructions for displaying a user verification interface. Some examples of the method, non-transitory computer-readable medium, and apparatus described above may further include processes, features, means, or instructions for receiving a user verification indication using the user verification interface, wherein the user verification indication comprises a signature, a biometric indicator, or both.

Some examples of the method, non-transitory computer-readable medium, and apparatus described above may further include processes, features, means, or instructions for identifying a customer location based at least in part on the cryptocurrency payment option. Some examples of the method, non-transitory computer-readable medium, and apparatus described above may further include processes, features, means, or instructions for verifying that the customer location may be within a same region as a merchant location, wherein the transaction verification may be based at least in part on the verification.

Some examples of the method, non-transitory computer-readable medium, and apparatus described above may further include processes, features, means, or instructions for receiving a subsequent indication that the customer may have selected a non-cryptocurrency payment option. Some examples of the method, non-transitory computer-readable medium, and apparatus described above may further include processes, features, means, or instructions for refraining from generating a subsequent machine readable label based at least in part on the non-cryptocurrency payment option.

In some examples of the method, non-transitory computer-readable medium, and apparatus described above, the one or more payment options include a cash payment option, a credit card payment option, a debit card payment option, or any combination thereof. In some examples of the method, non-transitory computer-readable medium, and apparatus described above, the product comprises a consumable product, a service, a durable product, a disposable product, or any combination thereof. In some examples of the method, non-transitory computer-readable medium, and apparatus described above, the indication that the customer may have selected the cryptocurrency option comprises a touch screen gesture. In some examples of the method, non-transitory computer-readable medium, and apparatus described above, the machine readable label comprises a quick response (QR) code, a bar code, an alpha-numerical code, or any combination thereof.

### BRIEF DESCRIPTION OF THE DRAWINGS

FIG. 1 shows a diagram of a merchant payment system that supports providing users with an option for selecting a cryoptocurrency payment method in accordance with aspects of the present disclosure.

FIG. 2 shows a diagram of a merchant payment apparatus that supports providing users with an option for selecting a cryoptocurrency payment method in accordance with aspects of the present disclosure.

FIG. 3 shows a flowchart of a process performed by a merchant payment system for providing users with an option for selecting a cryoptocurrency payment method in accordance with aspects of the present disclosure.

FIGS. 4 through 5 show flowcharts of processes performed by a merchant payment apparatus for providing users with an option for selecting a cryoptocurrency payment method in accordance with aspects of the present disclosure.

### DETAILED DESCRIPTION OF THE DRAWINGS

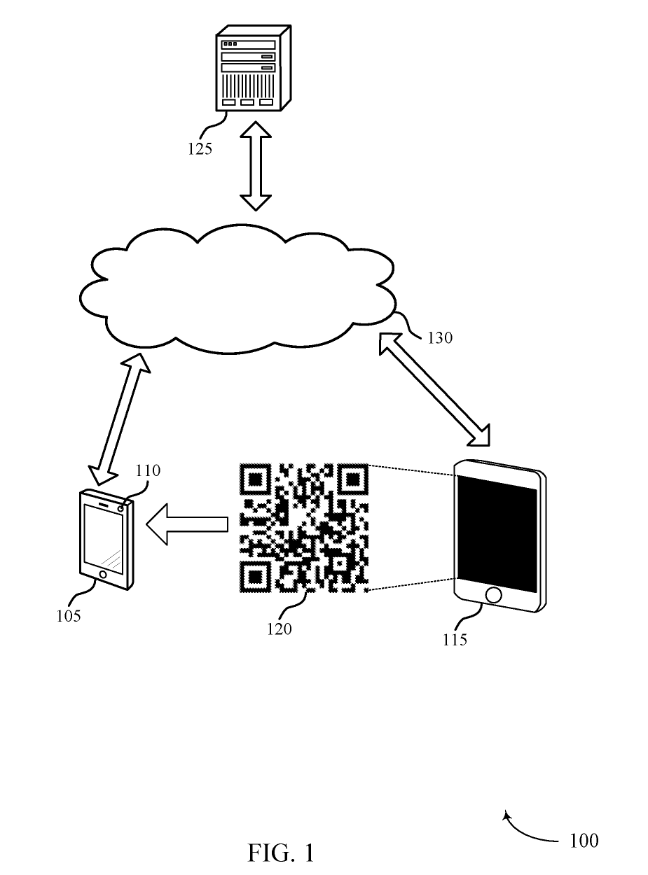

FIG. 1 shows a diagram 100 of a merchant payment system that supports providing users with an option for selecting a cryoptocurrency payment method in accordance with aspects of the present disclosure. Diagram 100 may include user device 105, merchant payment apparatus 115, and payment server 125. User device 105, merchant payment apparatus 115, and payment server 125 may communicate directly or via network 130.

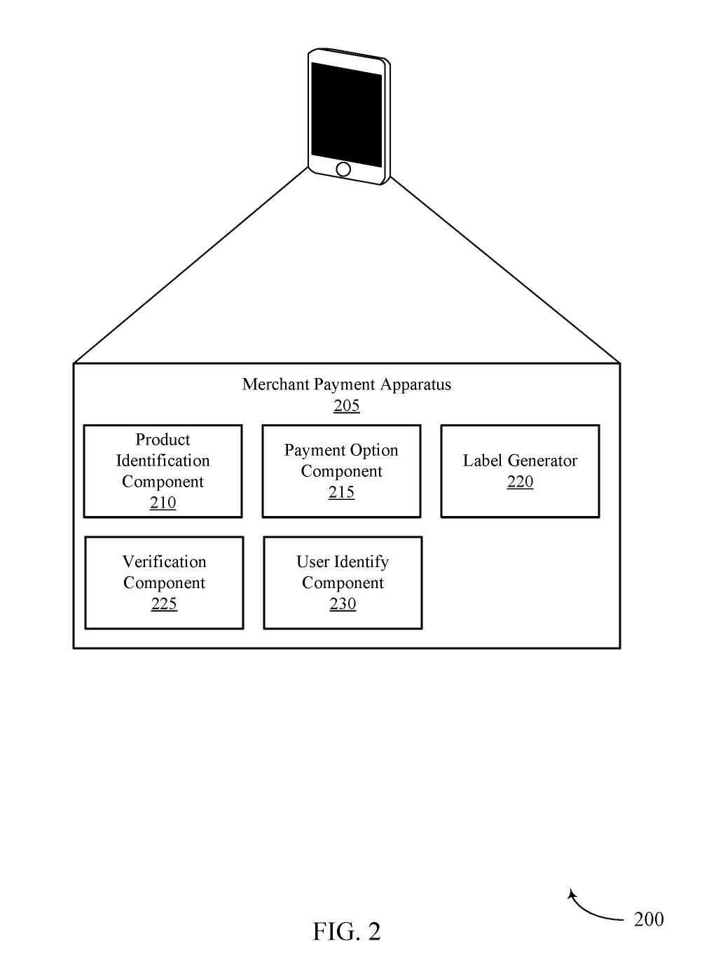

Merchant payment apparatus 115 may be used by a merchant (for example, a service provider) as a means to collect payment from customers. In some cases, a customer may select goods or services for purchase, and then select a payment option. Merchant payment apparatus 115 may present the user with multiple payment options, including cryptocurrency payment options and non-cryptocurrency payment options. If a cryptocurrency payment option is selected, merchant payment apparatus 115 may generate and display a machine readable label 120. Merchant payment apparatus 115 may incorporate aspects of merchant payment apparatus 205 as described with reference to FIG. 2.

In some examples, user device 105 may include label scanner 110. In some cases, the label scanner 110 may include a camera of the user device 105. In some examples, the label may be a software application that utilizes the camera of the user device 105. The label scanner 110 may scan the machine readable label 120 and then user device 105 may transmit a notification to the payment server 125.

The payment server 125 may then perform a cryptocurrency transaction, and may provide an indication to the merchant payment apparatus 115 that the transaction is valid (i.e., that the cryptocurrency transaction has been completed or that funds are available for the completion of the transaction). After the merchant payment apparatus 115 receives verification from the payment server 125, the sale may be completed.

FIG. 2 shows a diagram 200 of a merchant payment apparatus 205 that supports providing users with an option for selecting a cryoptocurrency payment method in accordance with aspects of the present disclosure. In some examples, merchant payment apparatus 205 may include product identification component 210, payment option component 215, label generator 220, verification component 225, and user identity component 230. Merchant payment apparatus 205 may incorporate aspects of merchant payment apparatus 115 as described with reference to FIG. 1. Merchant payment apparatus 205 may also include a processor and memory, and other components such as a display (not shown)

Product identification component 210 may identify a product for sale to a customer and present a plurality of product options, wherein identifying the product for sale to the customer is based at least in part on the plurality of product options. In some cases, the product comprises a consumable product, a service, a durable product, a disposable product, or any combination thereof.

Payment option component 215 may display one or more payment options, the one or more payment options including a cryptocurrency payment option; receive an indication that the customer has selected the cryptocurrency payment option; and, in some cases, receive a subsequent indication that the customer has selected a non-cryptocurrency payment option. In some cases, the one or more payment options include a cash payment option, a credit card payment option, a debit card payment option, or any combination thereof. In some cases, the indication that the customer has selected the cryptocurrency option comprises a touch screen gesture.

Label generator 220 may generate a machine readable label representing transaction information for the product based at least in part on the cryptocurrency payment option and refrain from generating a subsequent machine readable label based at least in part on the non-cryptocurrency payment option. In some cases, the machine readable label comprises a quick response (QR) code, a bar code, an alpha-numerical code, or any combination thereof.

Verification component 225 may receive a transaction verification from a payment server, wherein the transaction verification message is based at least in part on the machine readable label; display a transaction verification message to a user based on the transaction verification from the payment server; identify a transaction code from the transaction verification; compare the transaction code to the transaction information to verify the transaction; identify a customer location based at least in part on the cryptocurrency payment option; and verify that the customer location is within a same region as a merchant location, wherein the transaction verification is based at least in part on the verification.

User identity component 230 may display a user verification interface and receive a user verification indication using the user verification interface, wherein the user verification indication comprises a signature, a biometric indicator, or both.

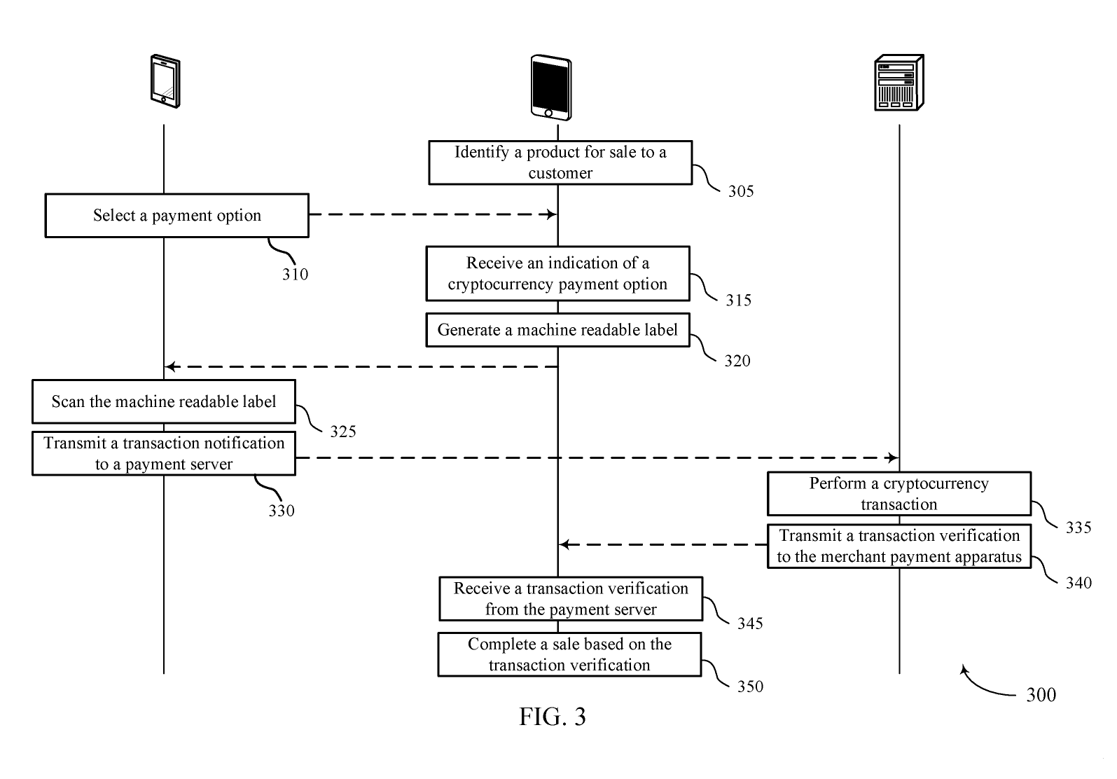

FIG. 3 shows a flowchart 300 of a process performed by a merchant payment system for providing users with an option for selecting a cryoptocurrency payment method in accordance with aspects of the present disclosure. In some examples, a merchant payment system may execute a set of codes to control functional elements of the merchant payment system to perform the described functions. Additionally or alternatively, a merchant payment system may use special-purpose hardware.

At block 305 the merchant payment apparatus may identify a product for sale to a customer. These operations may be performed according to the methods and processes described in accordance with aspects of the present disclosure. For example, the operations may be composed of various substeps, or may be performed in conjunction with other operations described herein. In certain examples, aspects of the described operations may be performed by merchant payment apparatus 115 and 205 as described with reference to FIGS. 1 and 2.

At block 310 the customer may select a payment option. These operations may be performed according to the methods and processes described in accordance with aspects of the present disclosure. For example, the operations may be composed of various substeps, or may be performed in conjunction with other operations described herein. In certain examples, aspects of the described operations may be performed by user (e.g., the customer or operator of the user device 105 as described with reference to FIG. 1).

At block 315 the merchant payment apparatus may receive an indication that the customer has selected the cryptocurrency payment option. These operations may be performed according to the methods and processes described in accordance with aspects of the present disclosure. For example, the operations may be composed of various substeps, or may be performed in conjunction with other operations described herein. In certain examples, aspects of the described operations may be performed by merchant payment apparatus 115 and 205 as described with reference to FIGS. 1 and 2.

At block 320 the merchant payment apparatus may generate a machine readable label representing transaction information for the product. These operations may be performed according to the methods and processes described in accordance with aspects of the present disclosure. For example, the operations may be composed of various substeps, or may be performed in conjunction with other operations described herein. In certain examples, aspects of the described operations may be performed by merchant payment apparatus 115 and 205 as described with reference to FIGS. 1 and 2.

At block 325 the user may scan the machine readable label. These operations may be performed according to the methods and processes described in accordance with aspects of the present disclosure. For example, the operations may be composed of various substeps, or may be performed in conjunction with other operations described herein. In certain examples, aspects of the described operations may be performed by user device 105 as described with reference to FIG. 1.

At block 330 the user device may transmit a transaction notification to a payment server. These operations may be performed according to the methods and processes described in accordance with aspects of the present disclosure. For example, the operations may be composed of various substeps, or may be performed in conjunction with other operations described herein. In certain examples, aspects of the described operations may be performed by user device 105 as described with reference to FIG. 1.

At block 335 the payment server may perform a cryptocurrency transaction based on the transaction notification. These operations may be performed according to the methods and processes described in accordance with aspects of the present disclosure. For example, the operations may be composed of various substeps, or may be performed in conjunction with other operations described herein. In certain examples, aspects of the described operations may be performed by payment server 125 as described with reference to FIG. 1.

At block 340 the payment server may transmit a transaction verification to the merchant payment apparatus. These operations may be performed according to the methods and processes described in accordance with aspects of the present disclosure. For example, the operations may be composed of various substeps, or may be performed in conjunction with other operations described herein. In certain examples, aspects of the described operations may be performed by payment server 125 as described with reference to FIG. 1.

At block 345 the merchant payment apparatus may receive a transaction verification from the payment server. These operations may be performed according to the methods and processes described in accordance with aspects of the present disclosure. For example, the operations may be composed of various substeps, or may be performed in conjunction with other operations described herein. In certain examples, aspects of the described operations may be performed by merchant payment apparatus 115 and 205 as described with reference to FIGS. 1 and 2.

At block 350 the merchant payment apparatus may complete a sale of the product based on the transaction verification. These operations may be performed according to the methods and processes described in accordance with aspects of the present disclosure. For example, the operations may be composed of various substeps, or may be performed in conjunction with other operations described herein. In certain examples, aspects of the described operations may be performed by merchant payment apparatus 115 and 205 as described with reference to FIGS. 1 and 2.

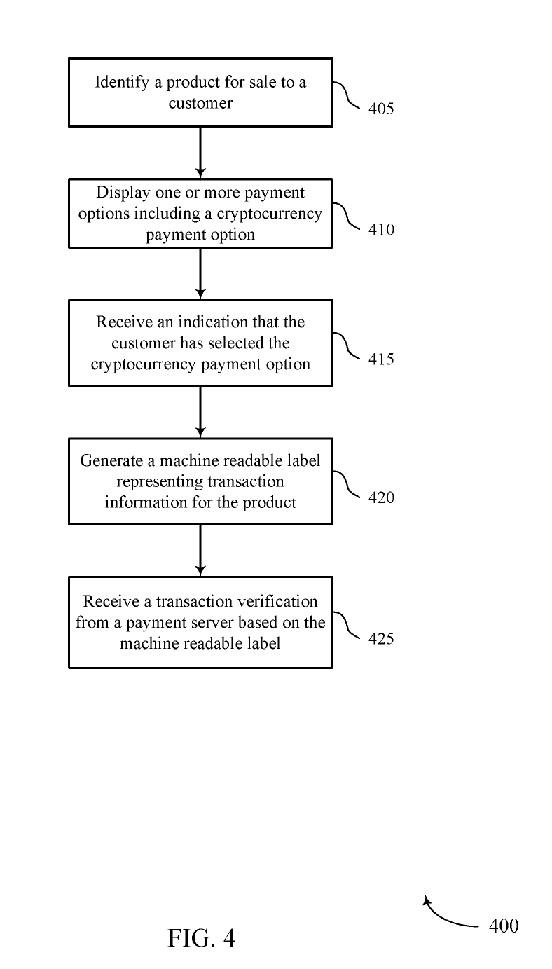

FIG. 4 shows a flowchart 400 of a process performed by a merchant payment apparatus for providing users with an option for selecting a cryoptocurrency payment method in accordance with aspects of the present disclosure. In some examples, a merchant payment apparatus may execute a set of codes to control functional elements of the merchant payment apparatus to perform the described functions. Additionally or alternatively, a merchant payment apparatus may use special-purpose hardware.

At block 405 the merchant payment apparatus may identify a product for sale to a customer. These operations may be performed according to the methods and processes described in accordance with aspects of the present disclosure. For example, the operations may be composed of various substeps, or may be performed in conjunction with other operations described herein. In certain examples, aspects of the described operations may be performed by product identification component 210 as described with reference to FIG. 2.

At block 410 the merchant payment apparatus may display one or more payment options including a cryptocurrency payment option. These operations may be performed according to the methods and processes described in accordance with aspects of the present disclosure. For example, the operations may be composed of various substeps, or may be performed in conjunction with other operations described herein. In certain examples, aspects of the described operations may be performed by payment option component 215 as described with reference to FIG. 2.

At block 415 the merchant payment apparatus may receive an indication that the customer has selected the cryptocurrency payment option. These operations may be performed according to the methods and processes described in accordance with aspects of the present disclosure. For example, the operations may be composed of various substeps, or may be performed in conjunction with other operations described herein. In certain examples, aspects of the described operations may be performed by payment option component 215 as described with reference to FIG. 2.

At block 420 the merchant payment apparatus may generate a machine readable label representing transaction information for the product. These operations may be performed according to the methods and processes described in accordance with aspects of the present disclosure. For example, the operations may be composed of various substeps, or may be performed in conjunction with other operations described herein. In certain examples, aspects of the described operations may be performed by label generator 220 as described with reference to FIG. 2.

At block 425 the merchant payment apparatus may receive a transaction verification from a payment server based on the machine readable label. These operations may be performed according to the methods and processes described in accordance with aspects of the present disclosure. For example, the operations may be composed of various substeps, or may be performed in conjunction with other operations described herein. In certain examples, aspects of the described operations may be performed by verification component 225 as described with reference to FIG. 2.

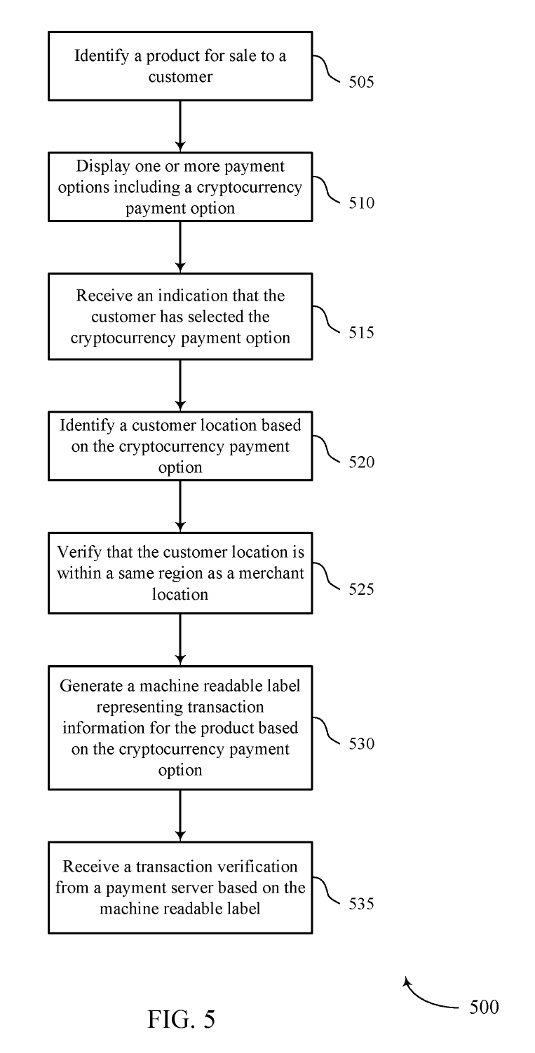

FIG. 5 shows a flowchart 500 of a process performed by a merchant payment apparatus for providing users with an option for selecting a cryoptocurrency payment method in accordance with aspects of the present disclosure. In some examples, a merchant payment apparatus may execute a set of codes to control functional elements of the merchant payment apparatus to perform the described functions. Additionally or alternatively, a merchant payment apparatus may use special-purpose hardware.

At block 505 the merchant payment apparatus may identify a product for sale to a customer. These operations may be performed according to the methods and processes described in accordance with aspects of the present disclosure. For example, the operations may be composed of various substeps, or may be performed in conjunction with other operations described herein. In certain examples, aspects of the described operations may be performed by product identification component 210 as described with reference to FIG. 2.

At block 510 the merchant payment apparatus may display one or more payment options including a cryptocurrency payment option. These operations may be performed according to the methods and processes described in accordance with aspects of the present disclosure. For example, the operations may be composed of various substeps, or may be performed in conjunction with other operations described herein. In certain examples, aspects of the described operations may be performed by payment option component 215 as described with reference to FIG. 2.

At block 515 the merchant payment apparatus may receive an indication that the customer has selected the cryptocurrency payment option. These operations may be performed according to the methods and processes described in accordance with aspects of the present disclosure. For example, the operations may be composed of various substeps, or may be performed in conjunction with other operations described herein. In certain examples, aspects of the described operations may be performed by payment option component 215 as described with reference to FIG. 2.

At block 520 the merchant payment apparatus may identify a customer location based on the cryptocurrency payment option. These operations may be performed according to the methods and processes described in accordance with aspects of the present disclosure. For example, the operations may be composed of various substeps, or may be performed in conjunction with other operations described herein. In certain examples, aspects of the described operations may be performed by verification component 225 as described with reference to FIG. 2.

At block 525 the merchant payment apparatus may verify that the customer location is within a same region as a merchant location. These operations may be performed according to the methods and processes described in accordance with aspects of the present disclosure. For example, the operations may be composed of various substeps, or may be performed in conjunction with other operations described herein. In certain examples, aspects of the described operations may be performed by verification component 225 as described with reference to FIG. 2.

At block 530 the merchant payment apparatus may generate a machine readable label representing transaction information for the product based on the cryptocurrency payment option. These operations may be performed according to the methods and processes described in accordance with aspects of the present disclosure. For example, the operations may be composed of various substeps, or may be performed in conjunction with other operations described herein. In certain examples, aspects of the described operations may be performed by label generator 220 as described with reference to FIG. 2.

At block 535 the merchant payment apparatus may receive a transaction verification from a payment server based on the machine readable label. These operations may be performed according to the methods and processes described in accordance with aspects of the present disclosure. For example, the operations may be composed of various substeps, or may be performed in conjunction with other operations described herein. In certain examples, aspects of the described operations may be performed by verification component 225 as described with reference to FIG. 2.

The description and drawings described herein represent example configurations and do not represent all the implementations within the scope of the claims. For example, the operations and steps may be rearranged, combined or otherwise modified. Also, structures and devices may be represented in the form of block diagrams to represent the relationship between components and avoid obscuring the described concepts. Similar components or features may have the same name but may have different reference numbers corresponding to different figures.

Some modifications to the disclosure may be readily apparent to those skilled in the art, and the principles defined herein may be applied to other variations without departing from the scope of the disclosure. Thus, the disclosure is not limited to the examples and designs described herein, but is to be accorded the broadest scope consistent with the principles and novel features disclosed herein.

The described methods may be implemented or performed by devices that include a general-purpose processor, a DSP, an ASIC, an FPGA or other programmable logic device, discrete gate or transistor logic, discrete hardware components, or any combination thereof. A general-purpose processor may be a microprocessor, a conventional processor, controller, microcontroller, or state machine. A processor may also be implemented as a combination of computing devices (e.g., a combination of a digital signal processor (DSP) and a microprocessor, multiple microprocessors, one or more microprocessors in conjunction with a DSP core, or any other such configuration). Thus, the functions described herein may be implemented in hardware or software and may be executed by a processor, firmware, or any combination thereof. If implemented in software executed by a processor, the functions may be stored in the form of instructions or code on a computer-readable medium.

Computer-readable media includes both non-transitory computer storage media and communication media including any medium that facilitates transfer of code or data. A non-transitory storage medium may be any available medium that can be accessed by a computer. For example, non-transitory computer-readable media can comprise RAM, ROM, electrically erasable programmable read only memory (EEPROM), compact disk (CD) ROM or other optical disk storage, magnetic disk storage, or any other non-transitory medium for carrying or storing data or code.

Also, connecting components may be properly termed computer-readable media. For example, if code or data is transmitted from a website, server, or other remote source using a coaxial cable, fiber optic cable, twisted pair, digital subscriber line (DSL), or wireless technology such as infrared, radio, or microwave signals, then the coaxial cable, fiber optic cable, twisted pair, digital subscriber line (DSL), or wireless technology are included in the definition of medium. Combinations of media are also included within the scope of computer-readable media.

In this disclosure and the following claims, the word “or” indicates an inclusive list such that, for example, the list of X, Y, or Z means X or Y or Z or XY or XZ or YZ or XYZ. Also the phrase “based on” is not used to represent a closed set of conditions. For example, a step that is described as “based on condition A” may be based on both condition A and condition B. In other words, the phrase “based on” shall be construed to mean “based at least in part on.”

What is claimed is:

1. A method for accepting payments with cryptocurrency, comprising:
identifying a product for sale to a customer;
displaying one or more payment options, the one or more payment options including a cryptocurrency payment option;
receiving an indication that the customer has selected the cryptocurrency payment option;
generating a machine readable label representing transaction information for the product based at least in part on the cryptocurrency payment option; and
receiving a transaction verification from a payment server, wherein the transaction verification message is based at least in part on the machine readable label.

2. The method of claim 1, further comprising:
displaying a transaction verification message to a user based on the transaction verification from the payment server.

3. The method of claim 1, further comprising:
presenting a plurality of product options, wherein identifying the product for sale to the customer is based at least in part on the plurality of product options.

4. The method of claim 1, further comprising:
identifying a transaction code from the transaction verification; and
comparing the transaction code to the transaction information to verify the transaction.

5. The method of claim 1, further comprising:
displaying a user verification interface; and
receiving a user verification indication using the user verification interface, wherein the user verification indication comprises a signature, a biometric indicator, or both.

6. The method of claim 1, further comprising:
identifying a customer location based at least in part on the cryptocurrency payment option; and
verifying that the customer location is within a same region as a merchant location, wherein the transaction verification is based at least in part on the verification.

7. The method of claim 1, further comprising:
receiving a subsequent indication that the customer has selected a non-cryptocurrency payment option; and
refraining from generating a subsequent machine readable label based at least in part on the non-cryptocurrency payment option.

8. The method of claim 1, wherein:
the one or more payment options include a cash payment option, a credit card payment option, a debit card payment option, or any combination thereof.

9. The method of claim 1, wherein:
the product comprises a consumable product, a service, a durable product, a disposable product, or any combination thereof.

10. The method of claim 1, wherein:
the indication that the customer has selected the cryptocurrency option comprises a touch screen gesture.

11. The method of claim 1, wherein:
the machine readable label comprises a quick response (QR) code, a bar code, an alpha-numerical code, or any combination thereof.

12. A non-transitory computer readable medium storing code for accepting payments with cryptocurrency, the code comprising instructions executable by a processor to:
identify a product for sale to a customer;
display one or more payment options, the one or more payment options including a cryptocurrency payment option;
receive an indication that the customer has selected the cryptocurrency payment option;
generate a machine readable label representing transaction information for the product based at least in part on the cryptocurrency payment option; and
receive a transaction verification from a payment server, wherein the transaction verification message is based at least in part on the machine readable label.

13. The non-transitory computer-readable medium of claim 12, wherein the code further comprises instructions executable by the processor to:
present a plurality of product options, wherein identifying the product for sale to the customer is based at least in part on the plurality of product options.

14. The non-transitory computer-readable medium of claim 12, wherein the code further comprises instructions executable by the processor to:
identify a transaction code from the transaction verification; and
compare the transaction code to the transaction information to verify the transaction.

15. The non-transitory computer-readable medium of claim 12, wherein the code further comprises instructions executable by the processor to:
identify a customer location based at least in part on the cryptocurrency payment option; and
verify that the customer location is within a same region as a merchant location, wherein the transaction verification is based at least in part on the verification.

16. An apparatus for accepting payments with cryptocurrency, comprising:
a processor; and
a memory storing instructions and in electronic communication with the processor, the processor being configured to execute the instructions to:
identify a product for sale to a customer;
display one or more payment options, the one or more payment options including a cryptocurrency payment option;
receive an indication that the customer has selected the cryptocurrency payment option;
generate a machine readable label representing transaction information for the product based at least in part on the cryptocurrency payment option; and
receive a transaction verification from a payment server, wherein the transaction verification message is based at least in part on the machine readable label.

17. The apparatus of claim 16, wherein the processor is further configured to execute the instructions to:
display a transaction verification message to a user based on the transaction verification from the payment server.

18. The apparatus of claim 16, wherein the processor is further configured to execute the instructions to:
present a plurality of product options, wherein identifying the product for sale to the customer is based at least in part on the plurality of product options.

19. The apparatus of claim 16, wherein the processor is further configured to execute the instructions to:
identify a transaction code from the transaction verification; and
compare the transaction code to the transaction information to verify the transaction.

20. The apparatus of claim 16, wherein the processor is further configured to execute the instructions to:
identify a customer location based at least in part on the cryptocurrency payment option; and
verify that the customer location is within a same region as a merchant location, wherein the transaction verification is based at least in part on the verification.
